(19) United States
(12) Patent Application Publication
(10) Pub. No.: US 2026/0091415 A1
(43) Pub. Date: Apr. 2, 2026

(54) FRAME ASSEMBLY FOR PRESSURE WASHER

(71) Applicant: Karcher North America, Inc., Aurora, CO (US)

(72) Inventors: Alfonso Praxedis Yamaguchi Rendon, Guadalupe (MX); Carlos Ramirez Gonzalez, Guadalupe (MX)

(73) Assignee: Karcher North America, Inc., Aurora, CO (US)

(21) Appl. No.: 19/342,015

(22) Filed: Sep. 26, 2025

Related U.S. Application Data
(60) Provisional application No. 63/700,523, filed on Sep. 27, 2024.

(51) Int. Cl. B08B 3/02

(52) U.S. Cl. CPC B08B 3/026; B08B 2203/0211

(57) ABSTRACT

A frame assembly for a pressure washer configured to allow access to interior components for servicing. The frame assembly comprises a control panel assembly and a frame with a plurality of supports that collectively define a trapezoidal shape around a top corner thereof. A cover of the control panel assembly may be manually disposed into a closed orientation for periods of operation and an open orientation for servicing. The cover is pivotally connected to vertical supports of both a first and a second side support assembly of the frame. In the closed orientation, the cover is disposed in a closed position and cross-section thereof substantially corresponds to the trapezoidal shape of the plurality of supports of the frame. In the open orientation, the cover is disposed in an open position and away from the frame in a non-obstructing relation to the interior components of the pressure washer.

This U.S. Non-Provisional Patent application claims the benefit of priority from U.S. Provisional Patent Application No. 63/700,523, filed on Sep. 27, 2024, the entire disclosures of which are hereby incorporated by reference.

### FIELD OF INVENTION

The present disclosure relates to user interfaces and control panel assemblies. In some embodiments, frame assemblies for pressure washers and other powered devices are provided that comprise user interfaces or control panel members as shown and described herein.

### DESCRIPTION OF THE RELATED ART

The ease of use and practicality associated with pressure washers generally makes them suitable to effectively clean various types of spaces, including large-scale and industrial-size spaces such as factories, warehouses, hangars, educational facilities, sports facilities and the like. However, proper and routine servicing of pressure washers is crucial not only for their optimal functioning, but also for their longevity as interior components and parts generally deteriorate with use, environmental conditions, extended periods of non-use, etc. Thus, it becomes important to ensure that the interior components of a pressure washer are monitored often and serviced on a regular basis. This becomes a challenge as often it may be difficult to physically access certain components of pressure washers, including those adjacent to a control panel or other outside components that cannot be easily removed. Compounding this issue is the fact that pressure washer frames are not always designed to facilitate access to interior components. As such, servicing the interior components of a pressure washer can be challenging.

Against this backdrop, there is a long-felt and unmet need in the industry to provide for a solution that overcomes the foregoing drawbacks. The industry would benefit by providing a frame assembly for pressure washers that would allow the user to selectively and/or manually adjust the position of a control panel assembly from a closed orientation for operation of the pressure washer to an open orientation, e.g., for servicing. Another benefit would be realized if such an inoperative or otherwise open position of the control panel assembly would provide access to the interior components of the pressure washer that would otherwise be concealed by the control panel assembly, for example, during periods of use of the pressure washer. An even further benefit would be realized if such control panel assembly were configured to correspond to the geometry of the top portion of the pressure washer frame Yet a further benefit would be achieved by providing hinged connections that would allow the user to manually and pivotally move the control panel assembly between the closed orientation and the open orientation.

### SUMMARY

Embodiments of the present disclosure are directed to frame assemblies for pressure washers configured to allow access to the interior components of the pressure washer, for example, a fuel tank for replenishing, a motor, an ignition, a water tank for replenishing, a water pump, hoses, connections, etc. The frame assembly generally comprises a frame with at least a first and a second side support assembly that collectively define an enclosure of the interior parts of the pressure washer. The first side support assembly and the second side support assembly are generally disposed in a spaced apart relation to one another and may be interconnected to one another via one or more transverse supports, which may be disposed around the contour of the frame.

Generally, a control panel assembly of the frame assembly is operatively disposed within the frame, for example, around a top corner thereof. The control panel assembly is operatively disposed within the frame and configured for disposition into and out of a closed orientation for operation of the pressure washer and an open orientation for servicing. As such, the controls and/or a display of the control panel assembly may be viewable and/or accessible by the user when the control panel assembly is disposed in the first position (i.e. the closed orientation). Conversely, when the control panel assembly is disposed in a second position (i.e. the open orientation), the control panel assembly is preferably disposed in a non-obstructing relation to the interior parts of the pressure washer, for example, for maintenance, servicing, replenishing cleaning fluids, fuel, etc.

The control panel assembly according to embodiments of the present disclosure generally comprises a cover configured and dimensioned to correspond to the shape of a top corner of the frame where the control panel assembly is disposed. In certain embodiments, the top corner is proximate to a handle bar of the frame for manually moving the pressure washer. The control panel assembly may also comprise a housing adjacently disposed to an interior face of the cover and configured to reciprocally move with the cover from the closed orientation to the open orientation, and vice versa. Thus, the cover of the control panel assembly may be configured and dimensioned to correspond to the shape of the frame, wherein a first end of the cover may be pivotally connected to both the first and second side support assemblies. For example, the cover may be pivotally connected to a vertical support of both the first and the second side support assemblies around a first end thereof.

Additionally, the cover is contemplated as being operatively configured with a locking assembly around a second end thereof to secure or otherwise retain the control panel assembly in the closed orientation. A first and/or a second locking structure of the locking assembly may be respectively disposed on a horizontal support of both the first and the second side support assemblies. Moreover, corresponding connecting supports of the first and the second side support assemblies may be configured and dimensioned to interconnect the vertical supports to their corresponding horizontal supports. As such, the supports of the side support assemblies may collectively define a trapezoidal or otherwise contoured shape of the frame around one of its top corners. It is contemplated that a cross-section of the cover should define a profile that at least partially corresponds to the shape defined by the supports of the first and the second support assembly.

The cover and/or the housing are generally configured to extend outward and away from the frame when a user disposes the control panel assembly into the open orientation thereby exposing and/or allowing access to the interior components of the pressure washer. Accordingly, the cover is generally disposable in a non-obstructing relation to the interior components of the pressure washer when the control panel assembly is disposed in the open orientation, including in a spaced apart relation to a handle bar of the frame. Conversely, the cover is generally disposed in a substantially coincident alignment to the first and the second side support assemblies when the control panel is disposed in the open orientation.

### BRIEF DESCRIPTION OF THE DRAWINGS

FIG. 1 is a perspective view of one embodiment of the frame assembly according to the present invention showing the control panel assembly being disposed in the closed orientation.

FIG. 2 is a side perspective view of another embodiment of the frame assembly according to the present invention showing the control panel assembly being disposed in the closed orientation.

FIG. 3 is a side perspective view of a portion of one embodiment of the frame assembly according to the present invention showing the control panel assembly being disposed in the open orientation.

FIG. 4 is a side perspective view of a portion of another embodiment of the frame assembly according to the present invention showing the control panel assembly being disposed in the open orientation.

FIG. 5 is a side view of one embodiment of the frame assembly according to the present invention showing the control panel assembly being disposed in the closed orientation.

FIG. 6 is a side view of another embodiment of the frame assembly according to the present invention showing the control panel assembly is disposed in the open orientation.

FIG. 7 is a perspective view of one embodiment of the control panel assembly according to the present invention showing the control panel being disposed in the operative position.

FIG. 8 is a perspective view of another embodiment of the control panel assembly according to the present invention showing the control panel being disposed in the inoperative position.

### DETAILED DESCRIPTION

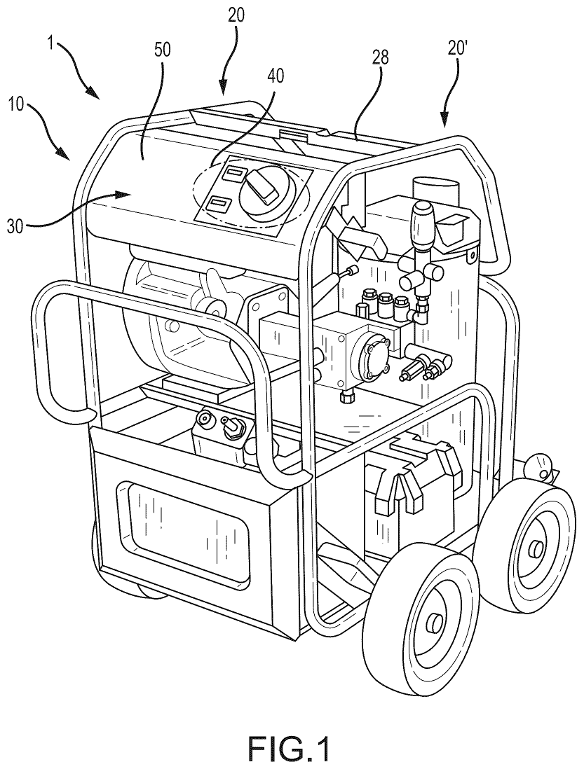

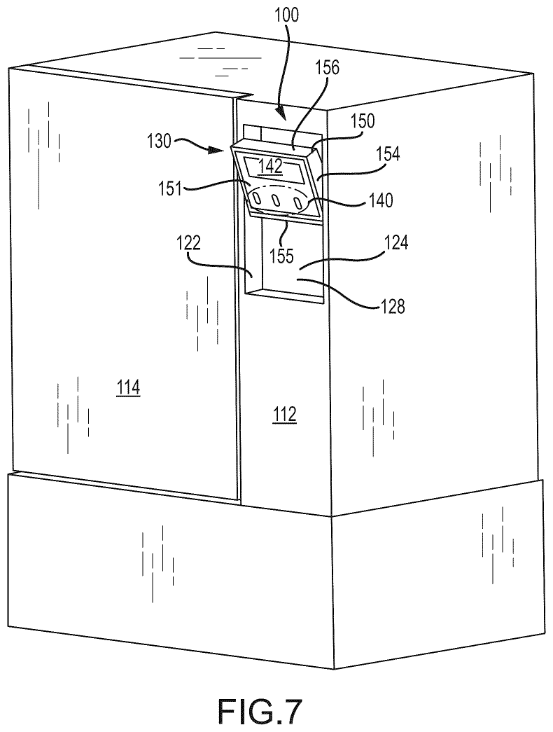

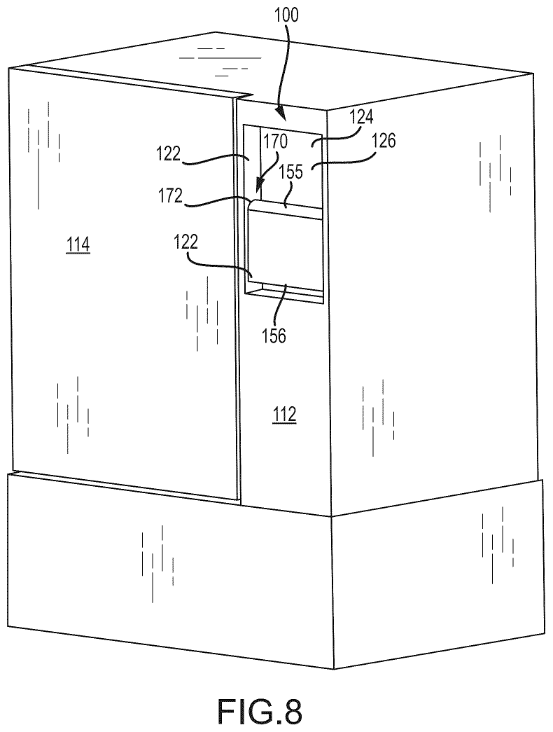

With initial reference to FIGS. 1-6, various embodiments according to the present disclosure are directed to a frame assembly 1 for pressure washers, including without limitation, industrial pressure washers and the like. The frame assembly 10 is generally intended to provide for a simple and convenient way to access interior components of the pressure washer via a control panel or control panel assembly 30 that may be disposed into and out of a closed orientation, e.g., for operation of the pressure washer, and an open orientation, e.g., for servicing and/or maintenance of the pressure washer components. With reference also to the illustrative embodiments of FIGS. 7-8, other embodiments of the present disclosure are directed to a control panel assembly 100 of a parts cleaning unit, a parts washer, and other powered devices. A control panel 130 of the control panel assembly 100 is generally configured for disposition into and out of an operative position, as shown in FIG. 7, and an inoperative position, as shown in FIG. 8.

As shown throughout FIGS. 1-6, the frame assembly 1 according to the depicted embodiments generally comprises a body 10 with a first and a second side. In one or more embodiments, the frame support assembly comprises a body 10 in the form of a frame with a first side support assembly and a second side support assembly, which are respectively indicated at 20 and 20′. In at least one embodiment, the body 10 comprises a tubular frame. The sides of the body or frame 10 and/or the support assemblies 20 and 20′ at least partially define an enclosure, or otherwise at least partially surround, the interior parts and/or components of the pressure washer, which may include without limitation, a motor, a water tank, a gas tank, a water pump, hoses, circuits, connections, valves, conduits, etc. Thus, various embodiments of the frame assembly 1 according to the present disclosure contemplate that each side and/or support assembly 20 and/or 20′ comprise a variety of supports that collectively define at least a portion of the shape of the body or frame 10.

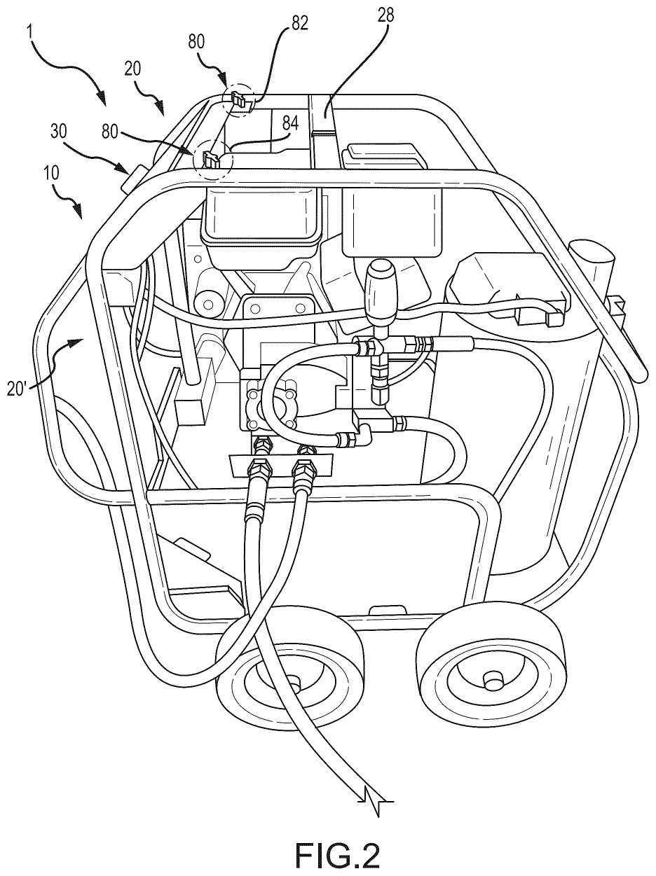

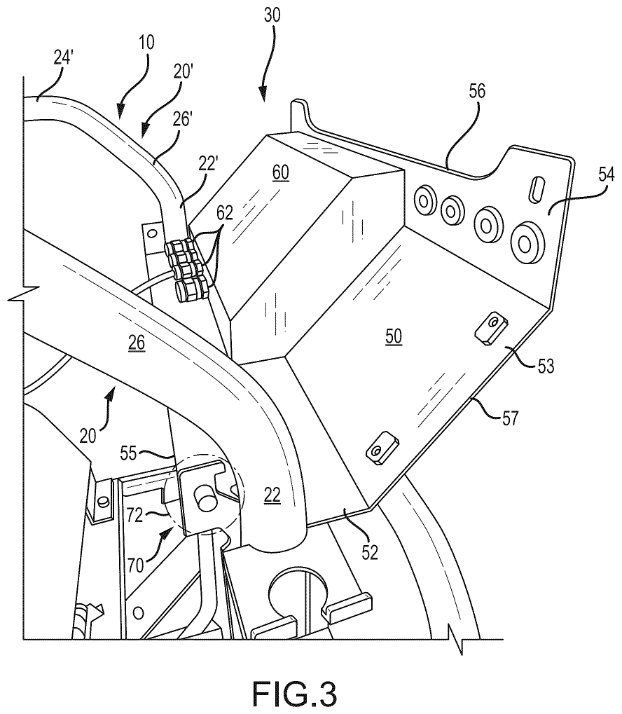

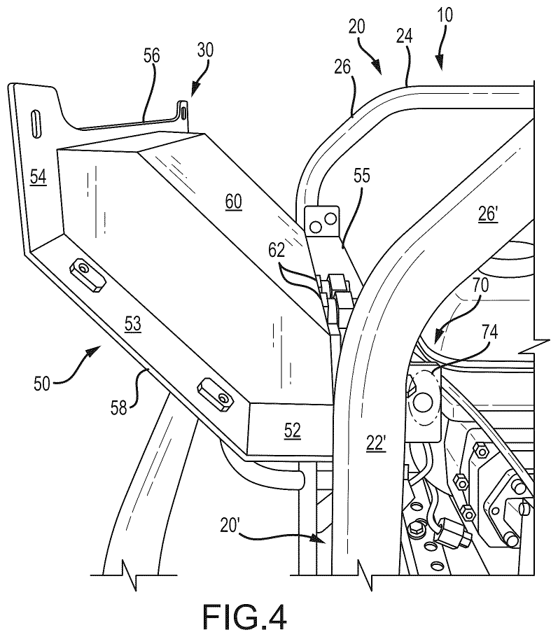

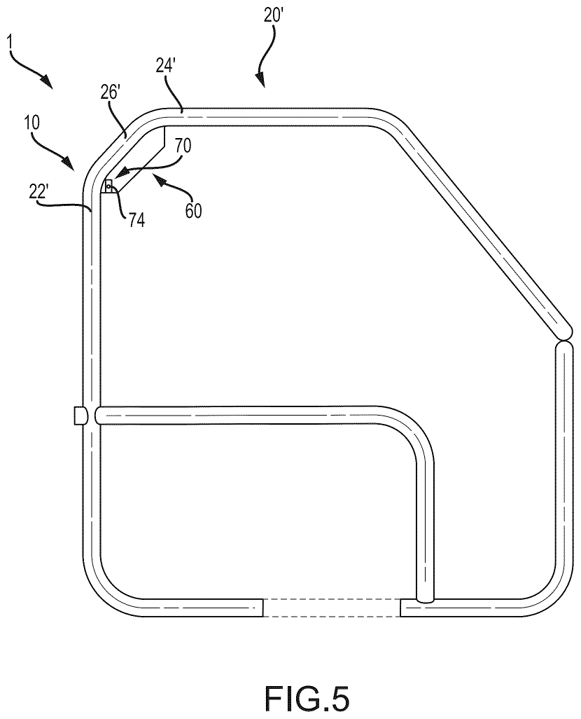

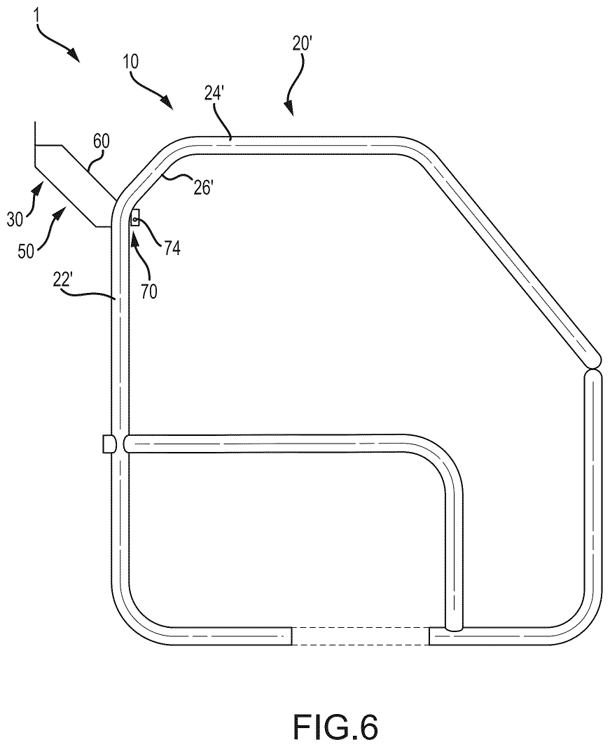

As shown in the embodiments of FIGS. 3-4, the sides of the body 10 and/or the side support assemblies 20 and/or 20′ generally comprise at least a vertical support 22 and/or 22′ and a horizontal support 24 and/or 24′ operatively connected to one another via a connecting support 26 and/or 26′. As shown in FIG. 1-6, in one or more embodiments, the connecting supports 26 and 26′ are disposed at an inclined relation to both the vertical support 22 and/or 22′ and the horizontal support 24 and/or 24′. As is perhaps best shown in FIGS. 5-6, in one or more embodiments, the connecting support 26 and/or 26′ is disposed at an inclined relation to a vertical axis 23 and/or a horizontal axis 25 defined along the length respectively of the vertical support 22, 22′ and the horizontal support 24, 24′. As such, in some embodiments the vertical support 22 and/or 22′, the horizontal support 24 and/or 24′ and the connecting support 26 and/or 26′ collectively define a trapezoidal shape of the frame 10, which is configured and dimensioned to accommodate control panel assembly 30. As shown in FIG. 2, in one or more embodiments both sides and/or side support assemblies 20 and 22′ are connected to one another via a transverse support 28.

With reference to at least FIG. 3-6, and as briefly mentioned above, a control panel assembly 30 is disposed on the frame 10 is disposable into and out of a closed orientation, as shown in FIGS. 1-2 and 5, and an open orientation, as shown in FIGS. 3-4 and 6. The control panel assembly 30 generally comprises a cover 50 with a screen and/or controls 40 for the pressure washer disposed on an exterior side thereof. The control panel assembly 30 also comprises a housing 60, which may be disposed on an opposite or interior face of the cover 50 and which may be configured and dimensioned to enclose a variety of controls, components, circuitry, etc., associated with the controls 40 or otherwise operation of the pressure washer.

The cover 50 is generally configured and dimensioned to substantially correspond to the contour of the body or frame 10 when the control panel assembly 30 is disposed in the closed orientation. That is, in some embodiments the cover 50 comprises a shape that substantially corresponds to the shape of the first sides and/or side support assemblies 20, 20′. For example, in one or more embodiments the cover 50 comprises a first portion 52 that is disposed substantially coplanar to the vertical supports 22 and 22′ and/or to the vertical plane when the control panel assembly 30 is disposed in the closed orientation. In some embodiments, the cover 50 further comprises a third portion 54 disposed substantially coplanar to the horizontal supports 24 and/or 24′ and/or to the horizontal plane when the control panel assembly 30 is disposed in the closed orientation. In at least one embodiment, a second portion 53 of the cover 50 is disposed substantially coplanar to the connecting supports 26 and 26′ when the control panel assembly 30 is disposed in the closed orientation.

As shown in the illustrative embodiment of FIG. 2, in some embodiments a locking assembly 80 is disposed on the frame 10 horizontal supports 24 and 24′ to secure the cover 50 to the frame 10 and enable the operative position of the control panel assembly 30. As shown in FIG. 2, in at least one embodiment a first locking structure 82 and a second locking structure 84 are disposed respectively on a top side of the horizontal supports 24 and 24′. In one or more embodiments, the locking structures 82 and 84 are configured and dimensioned to attach and/or retain the third portion 54 of the cover 50 to the body or frame 10 to enable the closed orientation, and to release it to enable the open orientation.

With reference to FIGS. 3-4 and 6, when the control panel assembly 30 is disposed in the open orientation both the cover 50 and the housing 60 are generally disposed in non-obstructing relation to the interior components of the pressure washer. As is perhaps best shown in the illustrative embodiments of FIGS. 3-4, the cover 50 is generally pivotally connected to both the first and the second side support assemblies 20 and 20′. For example, in some embodiments the first portion 52 of the cover 50 is pivotally connected to the vertical supports 22 and 22′ respectively around a first connection 72 and second connection 74 of a connection assembly 70. That is, in such embodiments the first and second connections 72 and 74 allow for a simultaneous rotational movement respectively of a first end 57 and second end 58 of the cover 50 away from the frame 10. As such, the control panel assembly 30 may be manually positioned from the closed orientation, as shown in FIGS. 1-2 and 5, to the open orientation, as shown in FIGS. 3-4 and 6.

When the control panel assembly 30 is disposed in the open orientation, the underside of the housing 60 and the opposite face of the cover 50 are exposed such that a user may access the interior components of the pressure washer. Furthermore, as shown in the illustrative embodiments of FIGS. 3-4, in one or more embodiments the housing 60 comprises at least one opening 62, and in some embodiments a plurality of openings 62, each one being configured and dimensioned to operatively connect cables and/or wiring to/from various components of the pressure washer, i.e., within the frame 10, to other components disposed on the interior of the housing 60, e.g., associated with the controls. The present invention contemplates that such cables and/or wiring comprise a sufficient length to allow for the movement of the control panel assembly 30 from the closed orientation to the open orientation. Nonetheless, the pressure washer is intended to operate in both the closed orientation and the open orientation.

As shown in the illustrative embodiments of FIGS. 3-4 and 6, when the control panel assembly 30 is disposed in the open orientation, the first portion 52 of the cover 50 are generally coincident to the vertical plane. In the open orientation, the third portion 54 is generally coincident to the vertical plane. As such, when the control panel assembly 30 is disposed in the open orientation, both the cover 50 and the housing 60 are generally disposed in a spaced apart relation to a handle bar of the frame 10. This is advantageous to avoid contact between the cover 50 and/or housing 60 and the handle bar of the frame 10 when the control panel assembly 30 is disposed in the open orientation. Such an intended position of the cover 50 when the control panel assembly 30 is disposed in the open orientation, including the spaced apart relation of the cover 50 with respect to the handle bar, may be achieved through a variety of mechanisms. Such mechanisms include without limitation a lanyard and/or chain connection, a hinged stop with various positions, fold up hinges, bi-fold hinges with adjustable tension, fold away hinges with a biasing mechanism, adjustable soft-down stay/up-swinging lifts, etc.

With reference to FIGS. 7-8 and as briefly mentioned above, the present invention is also directed to a control panel assembly 100 that may be disposed on a parts washer, part cleaning unit or part cleaning equipment, which for simplicity will be referred to as a “parts cleaner”. The control panel assembly 100 may be selectively disposable into and out of an operative position, as shown in the illustrative embodiment of FIG. 7, and an inoperative position, as shown in the illustrative embodiment of FIG. 8.

As shown in FIGS. 7-8, the parts cleaner may comprise a front side with a front panel 112 and/or a door 114, for example, for accessing an interior thereof to place and/or remove parts for cleaning. In some embodiments, the front panel 112, which may be adjacently disposed to the door 114, comprises a plurality of walls 122 and a support surface 124 that collectively define a recess 120 where a casing 150 of a control panel 130 is generally disposed. As contemplated herein, in one or more embodiments the casing 150 comprises a plurality of adjacently disposed sidewalls 154 connected to a back face 153 and a front face 151, which collectively define an extruded rectangular shape thereof. In some embodiments, the controls 155 and/or a display 142 are disposed on the front face 151 of the casing 150. Furthermore, in at least one embodiment a bottom end 155 of the casing 150 is pivotally connected within the recess 120, for example, around a middle portion thereof. For example, a connection assembly 170 comprising connections 172 is operatively disposed within the recess and/or the casing 150.

As such, the casing 150 of the control panel 130 may be rotated from the inoperative position, as shown in the illustrative embodiment of FIG. 8, to the operative position, as shown in the illustrative embodiment of FIG. 7. Various embodiments according to the present disclosure contemplate that the intended position of the casing 150 may be selectively achieved and/or maintained through a variety of mechanisms of the connections 172, which are generally at least partially disposed within the casing 150, for example, adjacent to the bottom end 155. Such mechanisms may comprise a hinged stop with various positions, fold up hinges, bi-fold hinges with adjustable tension, fold away hinges with a biasing mechanism, adjustable soft-down stay/up-swinging lifts, etc.

As shown in FIG. 7, when the control panel 130 is disposed in the operative position, a top end 156 of the casing 150 is disposable towards the top of the recess 120. In the operative position, the controls 155 and/or screen 142 may be viewable and/or accessible to a user standing in front of the parts cleaner and/or the front panel 112. As shown in the illustrative embodiment of FIG. 7, when in the operative position, the control panel 130 is disposed in any one of a plurality of tilted positions that the user may select for ease of viewing the screen 142 and/or controls 155. However, this is not strictly necessary as the back face 153 of the casing 150 may be disposed substantially against the top section 126 of the support surface 124.

Conversely, when the control panel 130 is disposed in the inoperative position or storage position, the front face 151 of the casing 150 should be concealed within the recess 120. That is, the front face 151 of the casing 150 may be disposed substantially against the bottom section 128 of the support surface 124, including in a substantially coincident alignment thereof. For example, the casing 150 may be manually rotated downward from the operative position shown in FIG. 7 to the inoperative position shown in FIG. 8. When the control panel 130 is disposed the inoperative position, the back face 153 of the casing 150 may be disposed away from the recess 120, including in a substantially coincident alignment to the vertical plane. Furthermore, when the control panel 130 is disposed in the inoperative position, the back face of the casing 150 may be disposed in a substantially parallel alignment to the front panel 112 and/or the door 114. In the open orientation, the control panel 130 is generally disposed in non-obstructing relation to the rest of the components of the parts cleaner.

In various embodiments according to the present disclosure, the casing 150 and recess 120 comprise one or more openings (not shown in the FIGS.) disposed in alignment to one another and dimensioned to accommodate the connections 172. On the casing 150, the openings are preferably disposed on the sidewalls 154, for example, around the bottom end 155. Thus, corresponding openings of the recess 120 are disposed on adjacent walls 122 around the same approximate location, i.e., around bottom end 155. Furthermore, wiring or cabling, e.g., for the operation of the controls 155 and/or screen 142, may be passed from an interior of the casing to an interior of the parts cleaner through corresponding pairs of aligned openings of the casing 150 and recess 120.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

What is claimed is:

1. A frame assembly for a pressure washer configured to allow access to interior components of the pressure washer, the frame assembly comprising:
a body configured and dimensioned to at least partially surround the interior components of the pressure washer;
a control panel assembly associated with the body and selectively disposable into and out of a closed orientation and an open orientation;
the control panel assembly comprising a cover and a housing collectively configured and dimensioned to at least partially correspond to a shape of the body; the cover being pivotally connected to the body;
the cover and the housing extending away from the body in non-obstructing relation to the interior components of the pressure washer when the control panel assembly is disposed in the open orientation; and
the cover disposed in a substantially coincident alignment to the first side support assembly and the second side support assembly when the control panel assembly is disposed in the closed orientation.

2. The frame assembly as recited in claim 1 wherein the control panel assembly comprises controls disposed on an exterior face of the cover and wherein the housing is disposed on an interior face of the cover that is opposite to the exterior face; wherein the housing and the cover are reciprocally movable with one another when the control panel assembly is disposed into and out of the closed orientation and the open orientation.

3. The frame assembly as recited in claim 2 wherein the housing is configured and dimensioned to enclose a plurality of components associated with a display or the controls of the control panel assembly.

4. The frame assembly as recited in claim 2 wherein the housing comprises at least one opening configured and dimensioned to communicably connect at least some of the interior components of the pressure washer to a display or the controls of the control panel assembly.

5. The frame assembly as recited in claim 1 wherein the cover of the control panel assembly comprises a first portion adjacently disposed to a second portion, the second portion being adjacently disposed to a third portion; and wherein the first portion, the second portion and the third portion collectively define a substantially trapezoidal cross section of the cover.

6. The frame assembly as recited in claim 5 wherein the body comprises a first side and a second side; each of the first side and the second side of the body comprising a vertical support and a horizontal support connected to one another via a connecting support; and wherein the connecting support is disposed at a substantially inclined relationship to both the vertical support and the horizontal support.

7. The frame assembly as recited in claim 6 wherein the first portion of the cover is substantially coincident to the vertical supports of both the first side and the second side of the body when the control panel assembly is disposed in the closed orientation.

8. The frame assembly as recited in claim 7 wherein the first portion of the cover is substantially coincident to the vertical plane when the control panel assembly is disposed in the closed orientation.

9. The frame assembly as recited in claim 6 wherein the first portion of the cover is substantially coincident to the horizontal plane when the control panel assembly is disposed in the open orientation.

10. The frame assembly as recited in claim 6 wherein the second portion of the cover is substantially coincident to the connecting supports of both the first side and the second side of the body when the control panel assembly is disposed in the closed orientation.

11. The frame assembly as recited in claim 6 wherein the third portion of the cover is substantially coincident to the horizontal supports of both the first side and the second side of the body when the control panel assembly is disposed in the closed orientation.

12. The frame assembly as recited in claim 11 wherein the third portion of the cover is substantially coincident the horizontal plane when the control panel assembly is disposed in the closed orientation.

13. The frame assembly as recited in claim 11 wherein the third portion of the cover is substantially coincident to the vertical plane when the control panel assembly is disposed in the closed orientation.

14. The frame assembly as recited in claim 1 wherein the cover is configured to extend away from the body and is in a spaced apart relation to a handle bar connected to the first side and the second side of the body when the control panel assembly is disposed in the open orientation.

15. The frame assembly as recited in claim 1 wherein the cover is pivotally movable away from the body and is configured to stop at a predetermined distance prior to contacting to a handle bar of the body when the control panel assembly is disposed in the closed orientation.

16. The frame assembly as recited in claim 1 wherein the cover is pivotally connected to the vertical support of both the first and the second side support assemblies.

17. The frame assembly as recited in claim 1 wherein the cover is pivotally connected to the body via at least one of a multiple position hinged stop, fold up hinges, bi-fold hinges with adjustable tension, fold away hinges with a biasing mechanism, or an adjustable soft-down stay/up-swinging lift.

18. The frame assembly as recited in claim 1 wherein the body comprises a locking assembly disposed on the horizontal support of both the first side and the second side of the body; the locking assembly configured to retain the cover in the closed orientation.

19. A frame assembly of a pressure washer configured to selectively allow access to interior components of the pressure washer, the frame assembly comprising:
a frame comprising at least a first side configured and dimensioned to at least partially surround the interior components of the pressure washer; the first side comprising a vertical support and a horizontal support connected to one another via a connecting support disposed at a substantially inclined relationship to both the vertical support and the horizontal support;
a control panel assembly operatively structured with the frame and selectively disposable into and out of a closed orientation and an open orientation;
the control panel assembly comprising a cover configured and dimensioned to at least partially correspond to a shape of the frame, a first end of the cover pivotally connected to the first side of the frame;
the cover extending outward from the frame in non-obstructing relation to the interior components of the pressure washer when the control panel assembly is disposed in the open orientation;
the cover disposed in a substantially coincident alignment to the first side of the frame when the control panel assembly is disposed in the closed orientation; and
the cover of the control panel assembly comprising a first portion adjacently disposed to a second portion; the second portion being adjacently disposed to a third portion; the first portion, the second portion and the third portion collectively defining a substantially trapezoidal cross-section of the cover.

20. A frame assembly of a pressure washer configured to selectively allow access to interior components of the pressure washer, the frame assembly comprising:
a tubular frame comprising a first side support assembly and a second side support assembly interconnected to one another; the first side support assembly and the second side support assembly disposed in spaced apart relation to one another and collectively configured and dimensioned to at least partially surround the interior components of the pressure washer; each of the first side support assembly and the second side support assembly comprising a vertical support and a horizontal support connected to one another via a connecting support disposed at a substantially inclined relationship to both the vertical support and the horizontal support;
a control panel assembly operatively structured with the tubular frame and selectively disposable into and out of a closed orientation and an open orientation,
the control panel assembly comprising a cover configured and dimensioned to at least partially correspond to a shape of the tubular frame; a first end of the cover pivotally connected to the first side support portion, and a second end of the cover pivotally connected to the second side support portion;
the cover extending outward from the tubular frame in non-obstructing relation to the interior components of the pressure washer when the control panel assembly is disposed in the open orientation;
the cover disposed in a substantially coincident alignment to the first side support assembly and the second side support assembly when the control panel assembly is disposed in the closed orientation;
the cover of the control panel assembly comprises a first portion adjacently disposed to a second portion; the second portion being adjacently disposed to a third portion; the first portion, the second portion and the third portion collectively defining a substantially trapezoidal cross section of the cover;
wherein the first portion of the cover is substantially coincident to the vertical supports of both the first side support assembly and the second side support assembly when the control panel assembly is disposed in the closed orientation; and
wherein the first portion of the cover is substantially coincident to the vertical plane and the horizontal plane when the control panel assembly is disposed respectively in the closed orientation and in the open orientation.
